(19) United States
(12) Patent Application Publication
(10) Pub. No.: US 2025/0021750 A1
(43) Pub. Date: Jan. 16, 2025

(54) API FOR DATA REPOSITORIES

(71) Applicant: International Business Machines Corporation, Armonk, NY (US)

(72) Inventors: Gregory R. Hintermeister, Rochester, MN (US); Sarah Mewhinney, Austin, TX (US); Kenneth Koepcke, Naperville, IL (US); Gregory Garber, Marblehead, MA (US); John Golden, New York City, NY (US)

(21) Appl. No.: 18/352,635

(22) Filed: Jul. 14, 2023

(51) Int. Cl. G06F 40/18; G06F 9/54

(52) U.S. Cl. CPC G06F 40/18; G06F 9/544

(57) ABSTRACT

Methods and systems for accessing a data repository include identifying target cells in an input data repository, including an input cell, an output cell, and a formula. An interface for the input data repository is generated that applies an input data value from a request to the input cell and that outputs a value from the output cell that is generated by the formula. A new value from a request is applied to the input cell using the interface. A value generated by the formula is outputted.

### BACKGROUND

The present invention generally relates to data access and, more particularly, to application programming interfaces (APIs) for data repositories.

While much information is stored in readily accessible forms, such as in databases that can be accessed with an appropriate query, other information is stored in forms that are less accessible. For example, modern spreadsheet software is used to store large volumes of data and, additionally, has the ability to implement programmatic manipulation of their data. It is difficult to interact with such data repositories in an automated way, frequently necessitating manual intervention by human beings to access and modify the information stored within them.

### SUMMARY

A method for accessing a data repository include identifying target cells in an input data repository, including an input cell, an output cell, and a formula. An interface for the input data repository is generated that applies an input data value from a request to the input cell and that outputs a value from the output cell that is generated by the formula. A new value from a request is applied to the input cell using the interface. A value generated by the formula is outputted.

A system for accessing a data repository includes a hardware processor and a memory that stores a computer program. When executed by the hardware processor, the computer program causes the hardware processor to identify target cells in an input data repository, including an input cell, an output cell, and a formula, to generate an interface for the input data repository that applies an input data value from a request to the input cell and that outputs a value from the output cell that is generated by the formula, to apply a new value from a request to the input cell using the interface, and to output a value generated by the formula.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a data repository access system that automatically learns an application programming interface (API) to access a data repository, in accordance with an embodiment of the present invention;

FIG. 2 is a block/flow diagram of a data repository access method that learns an API interface to access a data repository, in accordance with an embodiment of the present invention;

FIG. 3 is a diagram of a data repository in the form of a spreadsheet, having input cells and formula cells that perform processing on data values of the input cells, in accordance with an embodiment of the present invention;

FIG. 4 is a block diagram of a process for accessing the functions of a spreadsheet using an automatically generated API, in accordance with an embodiment of the present invention;

FIG. 5 is a block diagram of a request workflow orchestrator that accesses the functions of spreadsheets using automatically generated APIs, in accordance with an embodiment of the present invention; and

FIG. 6 is a block diagram of an exemplary computer processing system that generates APIs to access data repositories, in accordance with an embodiment of the present invention.

### DETAILED DESCRIPTION

To access the data that is stored in otherwise programmatically inaccessible formats, such as spreadsheets or files stored locally or in the cloud, the inputs, outputs, and formulas of the data repository may be learned. These learned attributes may be used to automatically generate an application programming interface (API) for the data repository, using natural language processing to generate labels. The API can subsequently be used to access the data stored within the data repository, so that access to, and update of, the data within the data repository can be more readily automated.

Thus, embodiments may accept an input repository or repositories and may identify areas within the input repository that represent inputs and areas that calculate output values. As a result of this process, a trained repository learning model may be generated. When a new data repository is provided, the repository learning model may be used to identify the inputs, the outputs, and the formulas that translate between them.

Streams of input, for example in the form of audio and text files, may further be used to assess for details such as specific key values or words. These key values and words may be extracted using natural language processing and are referred to herein as tokens. Tokens may be used to identify possible tags and saved repositories of information that may apply to information within the tokens.

Because the API is generated from learned information from the data repositories, it can be generally applied without knowing a format of the input repository in advance. Information about the tags of the input data repositories can be saved, making it easy to search for relevant repositories. This makes it possible to collect together data repositories spanning different fields and topics. Providing access to the functions embedded in semi-structured data repositories increases the flexibility and utility of those data repositories and thereby improves the functionality of the computer system as a whole.

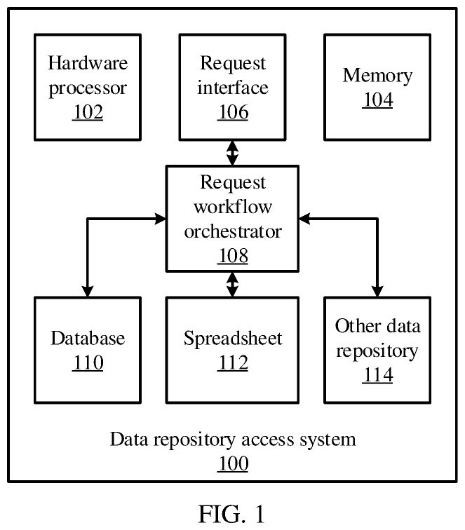

Referring now to FIG. 1, a data repository access system 100 is shown. The access system 100 includes a hardware processor 102 and a memory 104 that are used to execute one or more functional modules relating to the access of data in data repositories. A request interface 106 accepts written or spoken queries, for example using a user interface such as a microphone or keyboard.

The access system 100 may have access to a variety of different types of data repositories. For example, conventional databases 110 may be accessible using structured query language inputs. Additional types of data repositories are included as well, and may not have any predefined means for programmatic access to their contents. For example, a spreadsheet 112 may include a wide variety of data types, structured in an arbitrary way that is defined by its author. Thus spreadsheets 112 and other data repositories may be semi-structured data sources-having some structure, such as formulas, without being as well-defined as a structured database. The spreadsheet 112 may include executable instructions of its own, which take certain inputs and generate corresponding outputs.

Other types of data repository 114 are also contemplated, which may not resemble database 110 and spreadsheet 112, but which may nonetheless store information and which may have learnable inputs, outputs, and functionality. For example, an executable program may include its own internal data, stored according to a proprietary data format, that may be rendered accessible according to the present embodiments.

A request workflow orchestrator 108 translates between the request interface 106 and an appropriate data repository. For queries to a database 110, having a predefined query language or API, the request workflow orchestrator 108 may simply forward the query to the database 110 and report any results to the request interface 106.

For spreadsheets 112 and other data repositories 114, the request workflow orchestrator 108 may generate an appropriate API for the data repository in question. When queries are received at the request interface 106, the request workflow orchestrator 108 may use natural language processing to translate the queries into a form suitable for the generated API. The request workflow orchestrator 108 then executes the translated query on the data repository in question and reports any results to the request interface 106.

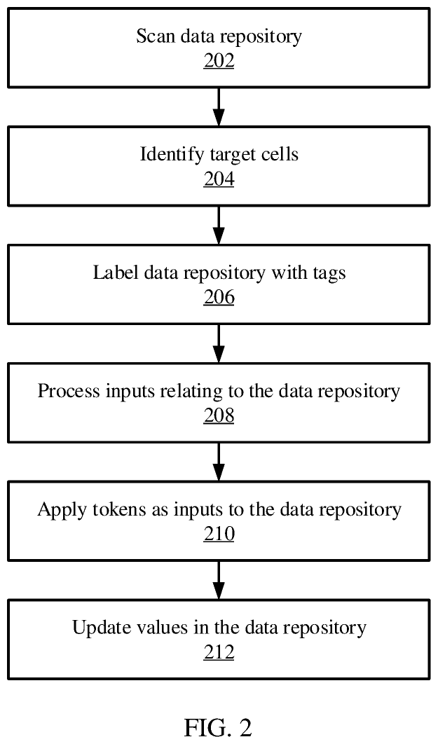

Referring now to FIG. 2, a method of learning and using a data repository is shown. Although this embodiment is described with a specific focus on spreadsheets 112, those having ordinary skill in the art would be able to adapt it to other data repositories 114 as well.

Block 202 scans the data repository to identify inputs and outputs. For example, every cell in spreadsheet 112 may be inspected and analyzed for dependencies. If there is a dependency, the cell may represent a formula. A formula in a spreadsheet may include a function that takes an input, performs some calculation or other action, and generates an output. Thus, for example, a given call may include a summation of the values of multiple other cells. The identified other cells represent inputs to the formula and the generated sum represents the output of the formula.

Block 204 can thereby represent the data repository as a collection of formulas and their inputs and outputs, for example identified as particular respective target cells within the spreadsheet 112. Block 206 may use text information in the target cells and in adjacent cells and column headers to generate tokens relating to the target cells. This token information helps to identify the function of the target cells. For example, if a given column header is, “number of CPUs,” then this may be identified as pertaining to a token, “CPUs: 23”. A corresponding output cell, such as “cost,” may then be returned. The target cell and token information may be stored for later use. In some cases, the outputs of formulas may be filtered according to whether they represent final outputs. For example, if the output of a given formula serves as the input to another formula, then it is not a final output and may be filtered out. The assignation of tags/tokens to target cells may be augmented by textual or audio inputs from subject matter experts, defining the contents of the cells.

Block 208 accepts inputs relating to the data repository. This input may include, for example, text or audio inputs. The inputs may be broken into tokens using natural language processing, and the tokens may be applied to the data repository. Multiple input streams may be analyzed, with low-confidence input tokens being picked out for verification by a human being. Tokens that are frequently repeated may be used to identify relevant repositories with similar tags. Block 210 may then apply the extracted tokens as inputs to the data repository and associated outputs may be reported.

Block 212 may update values of the data repository as needed. For example, key-value pairs may be used to update values of the spreadsheet 112, where the key may be a uniform resource indicator and the value may be a request for a value to use in changing the repository. Additionally, the workflow orchestrator 108 may have an internal data repository that stores the tokens associated with the spreadsheet 112. Block 212 may therefore update the workflow orchestrator 108 with more precise information about which cells of the spreadsheet to use as the inputs and outputs.

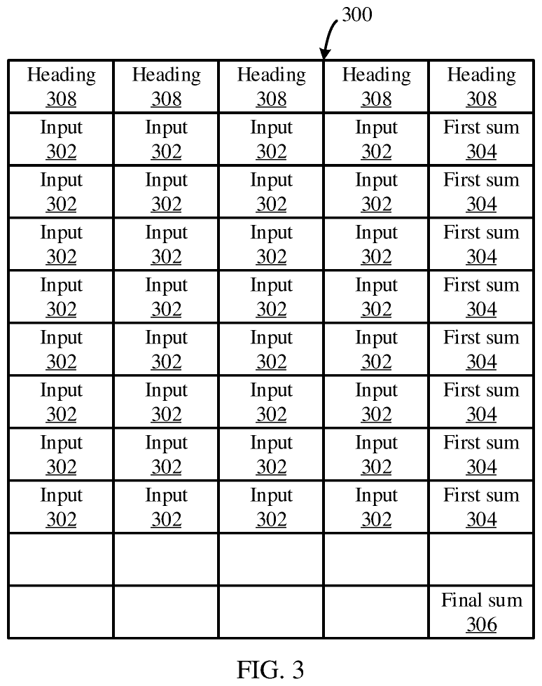

Referring now to FIG. 3, an exemplary spreadsheet 300 is shown. The spreadsheet includes multiple cells, arranged into rows and columns. Each cell may include a data value or a formula that calculates an output data value based on one or more input data values. Thus a set of input cells 302 are shown. Each input cell 302 may include a data value of any appropriate data type, such as numerical information or textual information. In the present example, the input cells 302 may include floating point numerical data, such as a dollar/cents value or a measurement generated by a sensor.

In some embodiments, not all cells of the spreadsheet 300 are necessarily filled by data values or formulas. Some may be empty, while some may include only formatting information intended to make it easier for a user to read and understand the spreadsheet 300. The spreadsheet 300 may include other cells that include data unrelated to the function of the spreadsheet 300, such as instructional information for users, descriptive information unrelated to the contents of the cells or formulas, ownership/authorship information, security information, and any other type of information or data that does not pertain to the functioning of the API. When identifying target cells for the API, the cells that are empty or that include data unrelated to the functioning of the spreadsheet may be ignored or filtered out.

A column of cells labeled first sum 304 are shown. These cells illustrate an intermediate formula, each of which takes a set of input cells 302 from a respective row as inputs and each of which generates a sum of the set of input cells 302 as an intermediate output. Thus the multiple first sums 304 may each generate an output data value that is the sum of the data values stored in input cells 302 from the same row.

A final sum 306 is shown below the first sums 304, and in this example the final sum 306 may accept the first sums 304 as inputs and may generate a sum of the first sums 304 as an output. In this example, the output value of the final sum 306 is not used by any other formula in the spreadsheet 300.

Although the formulas described in spreadsheet 300 are relatively simple, embodiments may use any number of such formulas, and the formulas may include any type of data processing. Appropriate formulas include, but are not limited to, arithmetic functions, statistical functions, calculus functions, data formatting functions, and text processing functions.

When processing the spreadsheet 300, the formulas 304 and 306 are identified and their respective inputs are further identified. Thus, the input cells 302 and the locations of the formulas' outputs are identified as target cells that are useful in implementing an API. Intermediate outputs, such as the outputs of the first sums 304, may be filtered so that they do not generate outputs in the API—such intermediate values may be unlikely to represent useful data that is sought by the person accessing the spreadsheet 300.

The spreadsheet 300 may include cells that describe the contents of other cells. For example, column headings 308 may include information relating to the data values and formulas stored in the cells of the respective columns. This information may be stored as tokens relating to the relevant cells of the spreadsheet 300 and can be used to identify inputs within subsequent input queries.

After the API for the spreadsheet 300 has been generated, the API may modify values of the spreadsheet 300 in accordance with inputs and queries. For example, a given query may provide data values to use in the inputs 302. The API may insert such values in the inputs 302 and may process the formulas, first sums 304 and final sum 306. Each formula generates respective output values, and the final output of final sum 306 is selected by the API to output as the result of the query.

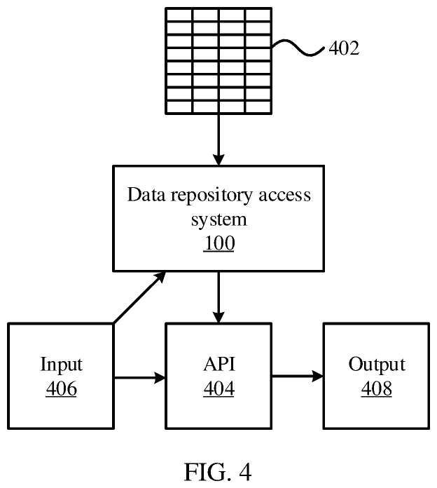

Referring now to FIG. 4, a diagram of generating and using an API for a data repository is shown. An input spreadsheet 402 is provided as an input. As described above, the input spreadsheet 402 may be include stored data as well as functions that process that stored data to produce an output.

The data repository access system 100 processes the spreadsheet 402 to learn the functions within the input spreadsheet. The data repository access system 100 generates and stores an API 404, which identifies target cells within the spreadsheet 402 to use as inputs and outputs. In some embodiments, the input spreadsheet 402 and the API 404 may be stored together, with the API 404 providing a way to access the functionality of the input spreadsheet 402. In some embodiments, the data repository access system 100 may replicate the functionality of the input spreadsheet 402 as a separate set of functionality that is implemented by the API 404, for example as a separate executable program with definite inputs and outputs.

The API 404 may later be accessed by users, for example by providing an input 406. The input 406 may, for example, include one or more data inputs that are appropriate for use with the input cells of the input spreadsheet 402. The input 406 may identify the input spreadsheet 402 explicitly, or may instead describe a requested functionality, for example using a natural language query. An appropriate API 404 may be selected from those stored by the data repository access system 100, for example by analyzing tokens within the input 406 and matching those tokens to tokens associated with the API 404.

The API 404 accepts the input 406 and matches any data values of the input 406 with input cells within the associated input spreadsheet 402. The functions of the input spreadsheet 402 are used to generate output data values, which the API 404 reads out and provides as output 408. In this way, access to the functions of the input spreadsheet 402 may be automated and used by any appropriate software application.

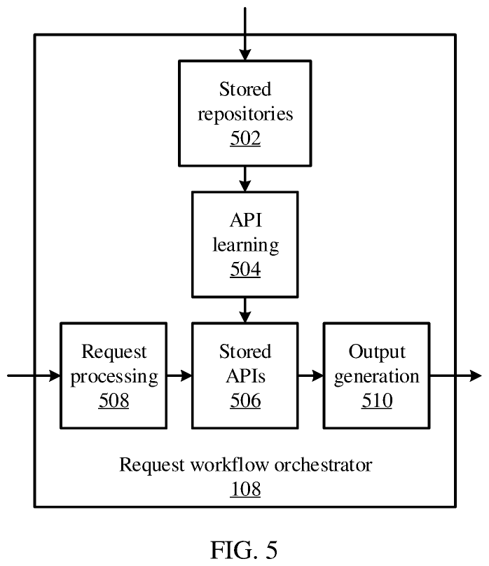

Referring now to FIG. 5, additional detail on the request workflow orchestrator 108 is shown, in the context of the example shown in FIG. 4. Input spreadsheets 402 may be received as input to the request workflow orchestrator 108 and may be stored with stored repositories. API learning 504 processes the input spreadsheet 402 to identify target cells and to associate the input spreadsheet with any appropriate tokens that may help identify the functions of the input spreadsheet 402. The API generated by the API learning 504 is stored with stored APIs 506, along with any appropriate tokens, tags, or other descriptive material.

Request processing 508 receives requests for a given data repository or function. In the event that the specific spreadsheet is not specified, the request processing 508 may identify tokens within the request to match the request with a data repository within the stored repositories 502. An appropriate API is selected from the stored APIs 506 and request processing 508 applies input data values from the request to input cells within the data repository that corresponds to the selected API. Output generation 510 collects the output values generated by the selected API.

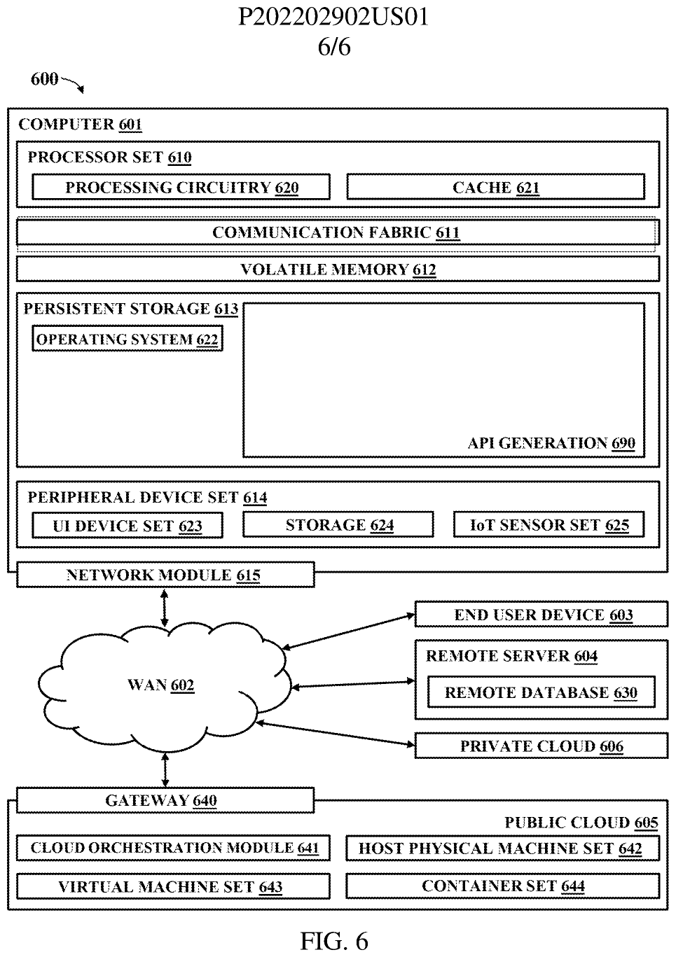

Referring now to FIG. 6, an exemplary computing environment 600 is shown. Computing environment 600 contains an example of an environment for the execution of at least some of the computer code involved in performing the inventive methods, such as API generation 690. In addition to block 200, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 614 includes the set of peripheral devices of computer 601. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then his historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of an API for data repositories (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for accessing a data repository, comprising:
identifying target cells in an input data repository, including an input cell, an output cell, and a formula;
generating an interface for the input data repository that applies an input data value from a request to the input cell and that outputs a value from the output cell that is generated by the formula;
applying a new value from a request to the input cell using the interface; and
outputting a value generated by the formula.

2. The method of claim 1, wherein the input data repository is a spreadsheet that includes a plurality of cells and at least one formula.

3. The method of claim 1, wherein identifying target cells includes:
identifying a plurality of formulas in the input data repository; and
filtering out intermediate formulas from the plurality of formulas.

4. The method of claim 3, wherein intermediate formulas are formulas that have an output value used as an input value by another formula.

5. The method of claim 4, further comprising selecting a final formula from the plurality of formulas that has an output value that is not used as an input value by another formula, wherein the final formula is the identified formula.

6. The method of claim 1, further comprising identifying a repository token within the input data repository associated with the target cells.

7. The method of claim 6, further comprising selecting the interface from a collection of stored interfaces responsive to an input token from the request based on a match between the input token and the repository token.

8. The method of claim 7, further comprising storing the interface in the collection of stored interfaces.

9. The method of claim 8, further comprising storing the input data repository in a collection of stored data repositories, wherein each of the stored data repositories is associated with a respective interface in the collection of stored interfaces.

10. The method of claim 1, wherein the interface is an application programming interface (API) that is accessible to automate access to the data repository.

11. A computer program product for accessing a data repository, the computer program product comprising a computer readable storage medium having program instructions embodied therewith, the program instructions executable by a hardware processor to cause the hardware processor to:
identify target cells in an input data repository, including an input cell, an output cell, and a formula;
generate an interface for the input data repository that applies an input data value from a request to the input cell and that outputs a value from the output cell that is generated by the formula;
apply a new value from a request to the input cell using the interface; and
output a value generated by the formula.

12. A system for accessing a data repository, comprising:
a hardware processor; and
a memory that stores a computer program which, when executed by the hardware processor, causes the hardware processor to:
identify target cells in an input data repository, including an input cell, an output cell, and a formula;
generate an interface for the input data repository that applies an input data value from a request to the input cell and that outputs a value from the output cell that is generated by the formula;
apply a new value from a request to the input cell using the interface; and
output a value generated by the formula.

13. The system of claim 12, wherein the input data repository is a spreadsheet that includes a plurality of cells and at least one formula.

14. The system of claim 12, wherein identifying target cells includes:
identifying a plurality of formulas in the input data repository; and
filtering out intermediate formulas from the plurality of formulas.

15. The system of claim 14, wherein intermediate formulas are formulas that have an output value used as an input value by another formula.

16. The system of claim 15, further comprising selecting a final formula from the plurality of formulas that has an output value that is not used as an input value by another formula, wherein the final formula is the identified formula.

17. The system of claim 12, further comprising identifying a repository token within the input data repository associated with the target cells.

18. The system of claim 17, further comprising selecting the interface from a collection of stored interfaces responsive to an input token from the request based on a match between the input token and the repository token.

19. The system of claim 18, further comprising storing the interface in the collection of stored interfaces.

20. The system of claim 19, further comprising storing the input data repository in a collection of stored data repositories, wherein each of the stored data repositories is associated with a respective interface in the collection of stored interfaces.
